(19) United States
(12) Patent Application Publication
(10) Pub. No.: US 2002/0147127 A1
(43) Pub. Date: Oct. 10, 2002

(54) Amine and quaternary ammonium salt derivatives of glycidyl ethers and glycidyl esters

(75) Inventors: Yun-Peng Zhu, Fort Lee, NJ (US); Cenk R. Burgazli, Cardington, OH (US); Shawn Zhu, Dublin, OH (US); James Lyle Hazen, Galloway, OH (US)

Correspondence Address: Michael P. Dilworth, CROMPTON CORPORATION, Benson Road, Middlebury, CT, 06749, US

(73) Assignee: CROMPTON CORPORATION

(21) Appl. No.: 10/082,295

(22) Filed: Feb. 26, 2002

Related U.S. Application Data
(60) Provisional application No. 60/281,899, filed on Apr. 5, 2001.

(51) Int. Cl. C11D 1/00

(52) U.S. Cl. 510/504

(57) ABSTRACT

A composition of matter is disclosed comprising a compound of the structural formula:

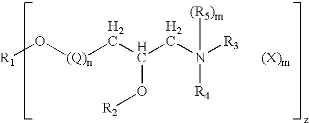

wherein

R₁ is C₈ to C₂₂ alkyl, C₈ to C₂₂ alkenyl, C₈ to C₂₂ ester alkyl, C₈ to C₂₂ ester alkenyl, C₈ to C₂₂ amido alkyl, or C₈ to C₂₂ amido alkenyl;

Q is CₚH₂ₚO;

n is an integer of from 0 to 60;

p is an integer of from 2 to 4;

R₂ is hydrogen, alkyl or ester alkyl of from 1 to 22 carbon atoms, or Q₁;

Q₁ is (CₚH₂ₚO)ₙ₁H;

R₃ is hydrogen, alkyl of from 1 to 22 carbon atoms, or Q₂;

Q₂ is (CₚH₂ₚO)ₙ₂H;

R₄ is hydrogen, alkyl of from 1 to 22 carbon atoms, or Q₃;

Q₃ is (CₚH₂ₚO)ₙ₃H;

R₅ is hydrogen, alkyl of from 1 to 22 carbon atoms, oxygen, betaine, amido amine, polyamine, polyamine alkoxylate, fatty amine, or Q₄;

Q₄ is (CₚH₂ₚO)ₙ₄H;

n1, n2, n3, and n4 are independently selected from the group consisting of integers of from 1 to 60;

X is a counterion selected from the group consisting of species generated from mineral or organic acids;

m is 0 or 1; and

z is 1 to 4.

Methods of making the composition and articles containing it are also disclosed.

I claim the benefit under Title 35, United States Code, §120 to U.S. Provisional Application No. 60/281,899, filed Apr. 5, 2001, entitled AMINE AND QUATERNARY AMMONIUM SALT DERIVATIVES OF GLYCIDYL ETHERS AND GLYCIDYL ESTERS

### BACKGROUND OF THE INVENTION

1. Field of the Invention

The present invention relates to the compounds of amine and quaternary ammonium salt derivatives of glycidyl ethers and glycidyl esters, preferably alkoxylated derivatives, which are useful in personal care, oil field, industrial and institutional cleaners, and agricultural formulations.

2. Description of Related Art

The reaction of alcohols with epichlorohydrin, which provides the intermediates for the compounds of the present invention, is known in the art.

U.K. Patent No. 1,164,095 discloses a method of preparing a photographic light-sensitive element by applying photographic coating compositions to a support, which method comprises incorporating in at least one coating composition before application a compound represented by the general formula:

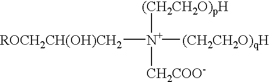

wherein R represents an alkyl group having 8-20 carbon atoms, and p and q each represents a positive integer.

U.S. Pat. No. 3,932,495 discloses a process for preparing quaternary ammonium compounds which contain both cationic and nonionic hydrophilic groups in the molecule. Alkylene oxide is reacted with aliphatic alcohol in the presence of an alkali catalyst at an elevated temperature; the resulting alkoxyglycol alcohol or ether is reacted with epichiorohydrin, producing the corresponding chloroglyceryl or chlorohydroxypropylene ether; and this is then reacted with a secondary amine to produce the quaternary ammonium compound.

U.S. Pat. No. 4,145,307 discloses water-in-oil emulsifiers that are obtained by reacting fatty alcohols with epichlorohydrin and reacting the resulting glycidyl ethers with amines.

U.S. Pat. No. 4,490,279 discloses foam stabilized compositions containing (a) a high foaming nonionic surfactant which is a block copolymer that is an alkylene oxide adduct of ethylene glycol, propylene glycol, or diethylene glycol, and (b) a foam-stabilizing amount of an amine oxide derived from a fatty alcohol which has been oxyethylated to the extent that ethylene oxide units account for approximately 50 to 75 weight percent of the molecular weight of the fatty alcohol-ethylene oxide adduct. The compositions are said to be useful in the formulation of various products in which foam stability is needed, such as hand detergent bars, hair shampoos, rug shampoos, hand dishwashing detergents, etc.

U.S. Pat. No. 6,176,906 B1 discloses a photo-curable antifogging composition which may be applied to substrates such as glass, various plastic materials and the like to give antifogging property on the surface of these substrates. The main ingredient of the composition is a quaternary ammonium salt of the following formula (1):

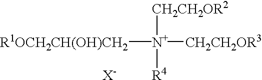

wherein: R¹ is CH₃(CH₂)ₙCH₂ or CH₃(CH₂)ₙCH₂C₆H₄ wherein n is an integer from 1 to 16 inclusive; R² and R³ are the same or different from each other, and represent CH₂═C(CH₃)COOCH₂ CH(OH)CH₂, CH₂═CHCOOCH₂CH(OH)CH₂ or H, with the proviso that R² and R³ may not be H at the same time; R⁴ is H, CH₃, CH₃CH₂ or CH₃CH₂CH₂; and X is CH₃OSO₃, CH₃CH₂OSO₃, CH₃COO, CF₃COO, CH₃(CH₂)ₙCOO wherein n is an integer from 1 to 16 inclusive, CH₃(CH₂)₇CH═CH(CH₂)₇COO, C₆H₅COO, C₆H₅CH(OH)COO, HOOCCH₂CH(OH)COO, Cl or Br.

Polish Patent No. 139,477 discloses the preparation of

RR₁R₂N⁺CH₂CH(OH)CH₂OOZCOO⁻

by reacting

ClCH₂CH(OH)CH₂OOCZCOOR₄

with

RR₁R₂N

wherein R is C₄₋₃₆ alkyl, C₄₋₃₆ alkenyl; R₁, R₂ are C₁₋₄ alkyl, hydroxyalkyl, (CH₂CH₂)ₙH, n is 1-16; Z is CH═CH, alkenyloxy, etc.; and R₄ is H, NH₄, alkenyloxy, etc. The compounds thus produced are said to be useful as antistatic agents, microbiocides, and sequestering agents for metals, such as Ca⁺⁺ and Fe⁺⁺⁺.

The disclosures of the foregoing are incorporated herein by reference in their entirety.

### SUMMARY OF THE INVENTION

The present invention is directed to compounds of amine and quaternary ammonium salt derivatives of glycidyl ethers and glycidyl esters. The derivatives are preferably alkoxylated. These compounds can be prepared by reacting alcohols, alcohol alkoxylates, fatty acids, or fatty acid alkoxylates with epichlorohydrin under acidic or basic conditions to produce alkyl glycidyl ethers or glycidyl esters, which are then reacted with amines or amine alkoxylates to produce the desired products.

More specifically, the present invention is directed to a composition of matter comprising a compound of the structural formula:

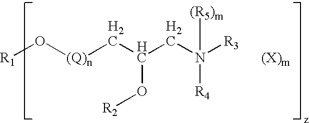

wherein

R₁ is C₈ to C₂₂ alkyl, C₈ to C₂₂ alkenyl, C₈ to C₂₂ ester alkyl, C₈ to C₂₂ ester alkenyl, C₈ to C₂₂ amido alkyl, or C₈ to C₂₂ amido alkenyl;

Q is CₚH₂ₚO;

n is an integer of from 0 to 60;

p is an integer of from 2 to 4;

R₂ is hydrogen, alkyl or ester alkyl of from 1 to 22 carbon atoms, or Q₁;

Q₁ is (CₚH₂ₚO)ₙ₁H;

R₃ is hydrogen, alkyl of from 1 to 22 carbon atoms, or Q₂;

Q₂ is (CₚHₚ₂O)ₙ₂H;

R₄ is hydrogen, alkyl of from 1 to 22 carbon atoms, or Q₃;

Q₃ is (CₚH₂ₚO)ₙ₃H;

R₅ is hydrogen, alkyl of from 1 to 22 carbon atoms, oxygen, betaine, amido amine, polyamine, polyamine alkoxylate, fatty amine, or Q₄;

Q₄ is (CₚH₂ₚO)ₙ₄H;

n1, n2, n3, and n4 are independently selected from the group consisting of integers of from 1 to 60;

X is a counterion selected from the group consisting of species generated from mineral or organic acids;

m is 0 or 1; and

z is 1 to 4.

In another embodiment, the present invention is directed to a method of making a compound of structural formula I comprising reacting a first compound selected from the group consisting of alcohols, alcohol alkoxylates, amidoalcohols, amidoalcohol alkoxylates, amidoamines, amidoamine alkoxylates, fatty acids, fatty acid alkoxylates, and mixtures thereof with epichlorohydrin under acidic or basic conditions to produce a glycidyl ether or a glycidyl ester; then reacting the glycidyl ether or glycidyl ester with a second compound selected from the group consisting of amines, amidoamines, amidoamine alkoxylates, and amine alkoxylates to produce a desired compound.

In still another embodiment, the present invention is directed to an article of manufacture comprising a compound of structural formula I.

### DESCRIPTION OF THE PREFERRED EMBODIMENTS

According to the present invention, a first compound selected from the group consisting of alcohols, alcohol alkoxylates, amidoalcohols, amidoalcohol alkoxylates, amidoamines, amidoamine alkoxylates, fatty acids, fatty acid alkoxylates, and mixtures thereof is reacted with epichlorohydrin under acidic or basic conditions to produce a glycidyl ether or a glycidyl ester. The glycidyl ether or glycidyl ester is then reacted with a second compound selected from the group consisting of amines, amidoamines, amidoamine alkoxylates, and amine alkoxylates to produce a third compound. This third compound has the structural formula:

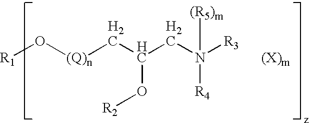

wherein

R₁ is C₈ to C₂₂ alkyl, C₈ to C₂₂ alkenyl, C₈ to C₂₂ ester alkyl, C₈ to C₂₂ ester alkenyl, C₈ to C₂₂ amido alkyl, or C₈ to C₂₂ amido alkenyl;

Q is CₚH₂ₚO;

n is an integer of from 0 to 60;

p is an integer of from 2 to 4;

R₂ is hydrogen, alkyl or ester alkyl of from 1 to 22 carbon atoms, or Q₁;

Q, is (CₚH₂ₚO)ₙ₁H;

R₃ is hydrogen, alkyl of from 1 to 22 carbon atoms, or Q₂;

Q₂ is (CₚH₂ₚO)ₙ₂H;

R₄ is hydrogen, alkyl of from 1 to 22 carbon atoms, or Q₃;

Q₃ is (CₚH₂ₚO)ₙ₃H;

R₅ is hydrogen, alkyl of from 1 to 22 carbon atoms, oxygen, betaine, amido amine, polyamine,

polyamine alkoxylate, fatty amine, or Q₄;

Q₄ is (CₚH₂ₚO)ₙ₄H;

n1, n2, n3, and n4 are independently selected from the group consisting of integers of from 1 to 60;

X is a counterion selected from the group consisting of species generated from mineral or organic acids;

m is 0 or 1; and

z is 1 to 4.

The amnines of the present invention can be prepared according to the following general equations, using, for convenience, the case where z in structural formula I is equal to 1:

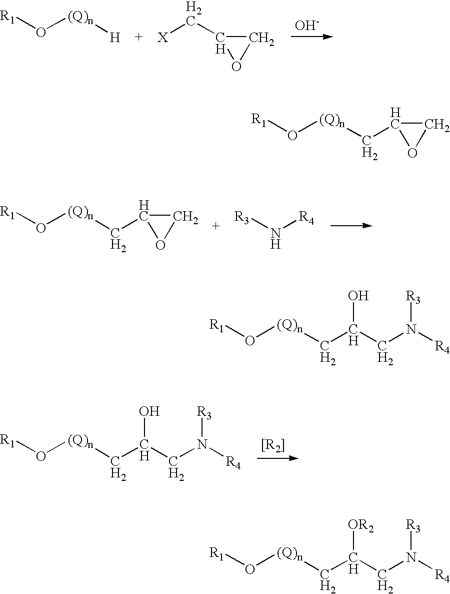

The quaternary ammonium salts of the present invention can be prepared according to the following general equations:

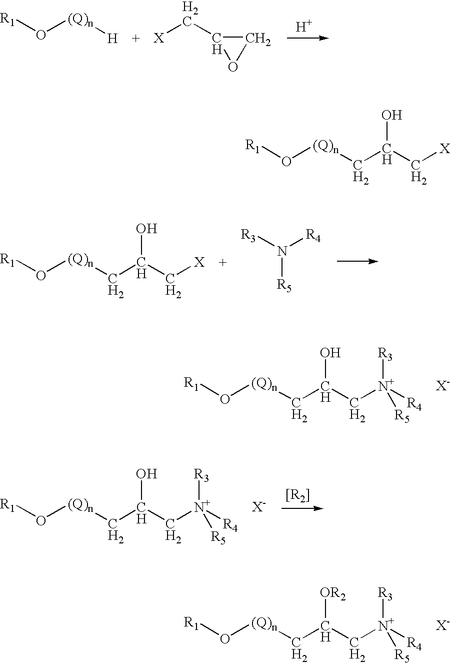

In a preferred embodiment of the present invention, ethoxylated amines of glycidyl ethers are prepared by first reacting a fatty alcohol with epichlorohydrin under basic conditions to obtain glycidyl ethers, which are then reacted with diethanolamine and then further reacted with ethylene oxide. This reaction process can be represented as follows:

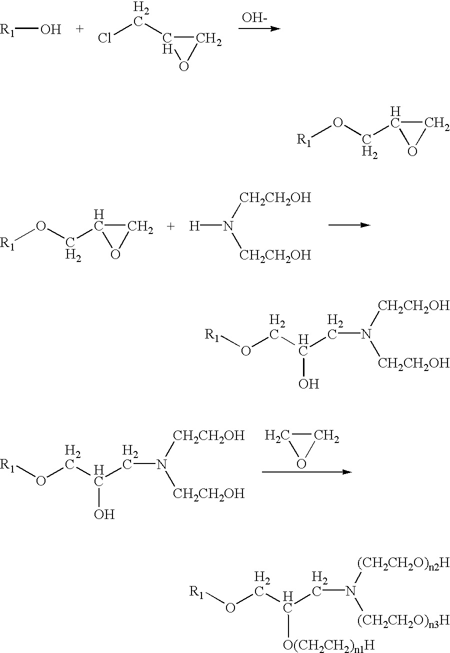

In another preferred embodiment of the present invention, ethoxylated amines of glycidyl ethers are prepared by first reacting a fatty alcohol with epichlorohydrin under acidic conditions to obtain glycidyl ethers, which are then reacted with ethoxylated methyl ethanolamine. This reaction process can be represented as follows:

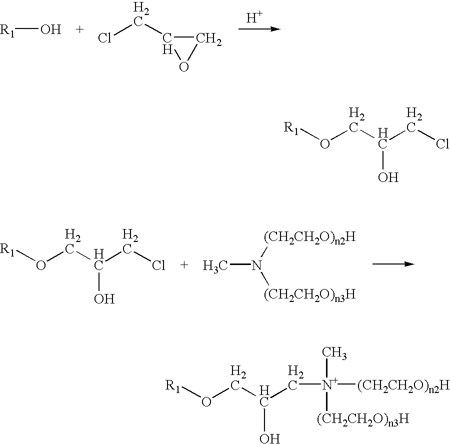

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

### Example 1

### C₁₂ Glycidyl Ether

A 2 liter flask was charged with 392.0 g of Exxal-12 (a C₁₂ alcohol) and 1.0 g of tetrabutylammonium chloride (TBAC). To this solution was added 101 g of NaOH (97%) and 50 g of heptanes with good agitation. A dispersion was formed. Then dispersion was heated to 50° C., and 224 g of epichlorohydrin was added dropwise, so as to control the reaction temperature below 75° C. After the epichlorohydrin addition was completed, the reaction was continued for about 2-3.0 hours at about 65° C. to complete the reaction. The reaction was monitored by gas chromatography. The salt thus formed was removed by filtration and the filtrates were condensed to give the desired Exxal-12 glycidyl ether. The structure was identified by IR and NMR, and its purity was examined by gas chromatography (GC).

### Example 2

### N,N-dihydroxyethyl-2-hydroxyl-3-alkyl(C₁₂)-oxy-propylamine

A quantity of 472.6 g of the Exxal-12 glycidyl ether prepared in Example 1 was charged to a one liter flask, and 167.8 g of diethanolamine was carefully added at 70° C. An exotherm was observed and the temperature was controlled below 100° C. After the reaction was under control, it was continued for about 2 hours at 90° C. The reaction was monitored by GC and the structure of the compound was confirmed by IR, and NMR.

### Example 3

### N,N-dihydroxyethyl-2-hydroxyl-3-alkyl(C₁₂)-oxy-propylamine ethoxylates

An autoclave was charged with 200 g of the N,N-dihydroxyethyl-2-hydroxyl-3-Exxal-oxy-propylamine prepared in Example 2 and 1.0 g of KOH (45% solution). After dehydration, ethylene oxide was introduced to the reactor to react with N,N-dihydroxyethyl-2-hydroxyl-3-Exxal-oxy-propylamine at 140° C. After the addition of the required amount of ethylene oxide was completed, the reaction mixture was digested at about 140-150° C. for about 30 minutes to yield the product, an ethoxylated amine of C₁₂ glycidyl ether.

### Example 4

### 1-Alkyl(C₁₂)-oxymethyl ethylenehydrin

A quantity of 115.3 g of epichlorohydrin was added to 187.6 g Exxal-12 in the presence of 0.38 g of a BF₃ acetic acid complex and the reaction temperature was controlled below 82° C. After the addition, the reaction was continued at 75° C. for about 3.0 hours. The progress of the reaction was monitored by GC and the chlorine content of the product was determined by titration.

Example 5

### Ethoxylated Quaternary Ammonium Salt of C₁₂ Glycidyl Ester

A mixture of the 100 g of the 1-alkyl(C₁₂)-oxymethyl ethylenehydrin prepared in Example 4 (chlorine content=14.6%) and 285.8 g of methanolamine ethoxylate (EO=15) was stirred in the presence of 2.0 g potassium carbonate at 110° C. for about 12 hours to yield the surfactant, an etboxylated quaternary ammonium salt of C₁₂ glycidyl ester.

In view of the many changes and modifications that can be made without departing from principles underlying the invention, reference should be made to the appended claims for an understanding of the scope of the protection afforded the invention.

What is claimed is:

1. A composition of matter comprising a compound of the structural formula: 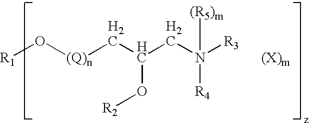
wherein
R₁ is C₈ to C₂₂ alkyl, C₈ to C₂₂ alkenyl, C₈ to C₂₂ ester alkyl, C₈ to C₂₂ ester alkenyl, C₈ to C₂₂ amido alkyl, or C₈ to C₂₂ amido alkenyl;
Q is CₚH₂ₚO;
n is an integer of from 0 to 60;
p is an integer of from 2 to 4;
R₂ is hydrogen, alkyl or ester alkyl of from 1 to 22 carbon atoms, or Q₁;
Q₁ is (CₚH₂ₚO)ₙ₁H;
R₃ is hydrogen, alkyl of from 1 to 22 carbon atoms, or Q₂;
Q₂ is (CₚH₂ₚO)ₙ₂H;
R₄ is hydrogen, alkyl of from 1 to 22 carbon atoms, or Q₃;
Q₃ is (CₚH₂ₚO)ₙ₃H;
R₅ is hydrogen, alkyl of from 1 to 22 carbon atoms, oxygen, betaine, amido amine, polyamine, polyamine alkoxylate, fatty amine, or Q₄;
Q₄ is (CₚH₂ₚO)ₙ₄H;
n1, n2, n3, and n4 are independently selected from the group consisting of integers of from 1 to 60;
X is a counterion selected from the group consisting of species generated from mineral or organic acids;
m is 0 or 1; and
z is 1 to 4.

2. A method of making a compound of the structural formula: 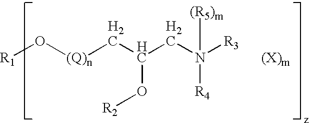
wherein
R₁ is C₈ to C₂₂ alkyl, C₈ to C₂₂ alkenyl, C₈ to C₂₂ ester alkyl, C₈ to C₂₂ ester alkenyl, C₈ to C₂₂ amido alkyl, or C₈ to C₂₂ amido alkenyl;
Q is CₚH₂ₚO;
n is an integer of from 0 to 60;
p is an integer of from 2 to 4;
R₂ is hydrogen, alkyl or ester alkyl of from 1 to 22 carbon atoms, or Q₁;
Q₁ is (CₚH₂ₚO)ₙ₁H;
R₃ is hydrogen, alkyl of from 1 to 22 carbon atoms, or Q₂;
Q₂ is (CₚH₂ₚO)ₙ₂H;
R₄ is hydrogen, alkyl of from 1 to 22 carbon atoms, or Q₃;
Q₃ is (CₚH₂ₚO)ₙ₃H;
R₅ is hydrogen, alkyl of from 1 to 22 carbon atoms, oxygen, betaine, amido amine, polyamine, polyamine alkoxylate, fatty amine, or Q₄;
Q₄ is (CₚH₂ₚO)ₙ₄H;
n1, n2, n3, and n4 are independently selected from the group consisting of integers of from 1 to 60;
X is a counterion selected from the group consisting of species generated from mineral or organic acids;
m is 0 or 1; and
z is 1 to 4;
wherein the method comprises reacting a first compound selected from the group consisting of alcohols, alcohol alkoxylates, amidoalcohols, amidoalcohol alkoxylates, amidoamines, amidoamine alkoxylates, fatty acids, fatty acid alkoxylates, and mixtures thereof with epichlorohydrin under acidic or basic conditions to produce a glycidyl ether or a glycidyl ester; then reacting the glycidyl ether or glycidyl ester with a second compound selected from the group consisting of amines, amidoamines, amidoamine alkoxylates, and amine alkoxylates to produce a desired compound.

3. An article of manufacture comprising a compound of the structural formula: 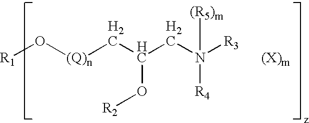
wherein
R₁ is C₈ to C₂₂ alkyl, C₈ to C₂₂ alkenyl, C₈ to C₂₂ ester alkyl, C₈ to C₂₂ ester alkenyl, C₈ to C₂₂ amido alkyl, or C₈ to C₂₂ amido alkenyl;
Q is CₚH₂ₚO;
n is an integer of from 0 to 60;
p is an integer of from 2 to 4;
R₂ is hydrogen, alkyl or ester alkyl of from 1 to 22 carbon atoms, or Q₁;
Q₁ is (CₚH₂ₚO)ₙ₁H;
R₃ is hydrogen, alkyl of from 1 to 22 carbon atoms, or Q₂;
Q₂ is (CₚH₂ₚO)ₙ₂H;
R₄ is hydrogen, alkyl of from 1 to 22 carbon atoms, or Q₃;
Q₃ is (CₚH₂ₚO)ₙ₃H;
R₅ is hydrogen, alkyl of from 1 to 22 carbon atoms, oxygen, betaine, amido amine, polyamine, polyamine alkoxylate, fatty amine, or Q₄;
Q₄ is (CₚH₂ₚO)ₙ₄H;
n1, n2, n3, and n4 are independently selected from the group consisting of integers of from 1 to 60;
X is a counterion selected from the group consisting of species generated from mineral or organic acids;
m is 0 or 1; and
z is 1 to 4.

4. The article of manufacture of claim 3 wherein said article is an agricultural formulation.

5. The article of manufacture of claim 3 wherein said article is selected from the group consisting of hand detergent bars, hair shampoos, rug shampoos, and hand dishwashing detergents.

6. The article of manufacture of claim 3 wherein said article is an industrial and institutional cleaner.
